(19) United States
(12) Patent Application Publication
(10) Pub. No.: US 2018/0234613 A1
(43) Pub. Date: Aug. 16, 2018

(54) IMAGE PICKUP APPARATUS

(71) Applicant: CANON KABUSHIKI KAISHA, Tokyo (JP)

(72) Inventor: Kentaro Fukunaga, Yokohama-shi (JP)

(21) Appl. No.: 15/753,047

(22) PCT Filed: Jul. 25, 2016
(86) PCT No.: PCT/JP2016/003446

§ 371 Date: Feb. 15, 2018

(30) Foreign Application Priority Data
Aug. 18, 2015 (JP) 2015-161356

(51) Int. Cl. H04N 5/232; F16M 11/20; F16M 11/10; F16M 11/22

(52) U.S. Cl. CPC H04N 5/23206; H04N 5/23296; F16M 11/18; F16M 11/10; F16M 11/22; F16M 11/2014

(57) ABSTRACT

A pan head includes a rotation unit configured to rotate a supporting portion in a predetermined direction, a storage unit configured to store a parameter used to control the rotation unit, a determination unit configured to determine an acceleration setting when the rotation unit rotates the supporting portion which is included in the parameter, and an acquisition unit configured to acquire apparatus information of an image pickup apparatus. Acceleration settings stored in the storage unit include an acceleration setting associated with the apparatus information. The determination unit determines an acceleration setting at the time of rotation of the supporting portion on the basis of the acceleration setting associated with the apparatus information acquired by the acquisition unit.

### TECHNICAL FIELD

The present invention relates to image pickup apparatuses capable of transmitting a captured image to a terminal via a network, and, more particularly, to an image pickup apparatus including a movable image pickup unit.

### BACKGROUND ART

A technique for changing the direction of a pan head on which an image pickup apparatus is mounted in accordance with an instruction transmitted from an external apparatus connected to the pan head via a network is known.

PTL 1 discloses a technique for changing an image capturing direction by controlling the movement direction of a pan head through the key operation of a mobile telephone having a browser function or the mouse operation of a personal computer. The variety of uses for such image pickup apparatuses has increased, and includes, for example, monitoring and video conference. Such an image pickup apparatus is used for a PTZ camera capable of adjusting a pan direction, a tilt direction, and a zoom direction.

### CITATION LIST

### Patent Literature

PTL 1: Japanese Patent Laid-Open No. 2003-8973

### SUMMARY OF INVENTION

When an image pickup apparatus is placed on a pan head and is used as a PTZ camera, the image pickup apparatus may vibrate as a result of resonance due to the weight and shape of the image pickup apparatus or the pan head or the weight and material of a rotation mechanism at the time of an operation. At that time, there is a desire to avoid specific conditions under which vibration occurs. A user therefore needs to make an operational instruction for the image pickup apparatus using an external apparatus so that vibration does not occur.

However, it is difficult for a user who operates a PTZ camera to know what an image pickup apparatus mounted on a distant pan head is. The user therefore sometimes cannot make an appropriate instruction for the image pickup apparatus.

The present invention provides a technique for automatically performing the appropriate setting of an image pickup apparatus mounted on a pan head.

### Solution to Problem

An image pickup apparatus according to an embodiment of the present invention has, for example, the following configuration.

A pan head according to an embodiment of the present invention which is provided with a communication unit for communicating with an external apparatus via a network and a supporting portion that supports an image pickup apparatus includes a rotation unit configured to rotate the supporting portion in a predetermined direction, a storage unit configured to store a parameter used to control the rotation unit, a determination unit configured to determine an acceleration setting when the rotation unit rotates the supporting portion which is included in the parameter, and an acquisition unit configured to acquire apparatus information of the image pickup apparatus. Acceleration settings stored in the storage unit include an acceleration setting associated with the apparatus information. The determination unit determines an acceleration setting at the time of rotation of the supporting portion on the basis of the acceleration setting associated with the apparatus information acquired by the acquisition unit.

Further features of the present invention will become apparent from the following description of exemplary embodiments with reference to the attached drawings.

### BRIEF DESCRIPTION OF DRAWINGS

FIG. 1A is a diagram illustrating the configuration of an image pickup system according to a first embodiment of the present invention.

FIG. 1B is a diagram illustrating the configuration of an image pickup system according to the first embodiment.

FIG. 1C is a diagram illustrating the configuration of an image pickup system according to the first embodiment.

FIG. 2A is a block diagram of a camera.

FIG. 2B is a block diagram of a pan head.

FIG. 2C is a block diagram of a client.

FIG. 3 is a sequence diagram illustrating the automatic setting of Ramp.

FIG. 4 is a diagram describing a sequence written in XML.

FIG. 5 is a diagram describing a sequence written in XML.

FIG. 6 is a sequence diagram illustrating the automatic setting of Ramp.

FIG. 7 is a diagram describing Ramp.

FIG. 8A is a sequence diagram illustrating pan/tilt operation control.

FIG. 8B is a sequence diagram illustrating pan/tilt operation control.

FIG. 9 is a diagram illustrating a table used to set Ramp.

FIG. 10 is a flowchart illustrating a process of setting Ramp in accordance with a movement distance at the time of rotation.

FIG. 11 is a table used to set Ramp.

FIG. 12 is a flowchart illustrating a process of setting Ramp in accordance with the sound of rotation.

FIG. 13 is a table used to set Ramp.

### DESCRIPTION OF EMBODIMENTS

Embodiments of the present invention will be described in detail below with reference to the accompanying drawings.

Configurations described in the following embodiments are illustrative only, and are not intended to limit the scope of the present invention. Commands described in the following embodiments are determined in accordance with, for example, the Open Network Video Interface Forum (ONVIF) standard. In the following embodiments, a rotation speed-time characteristic is sometimes referred to as Ramp.

### First Embodiment

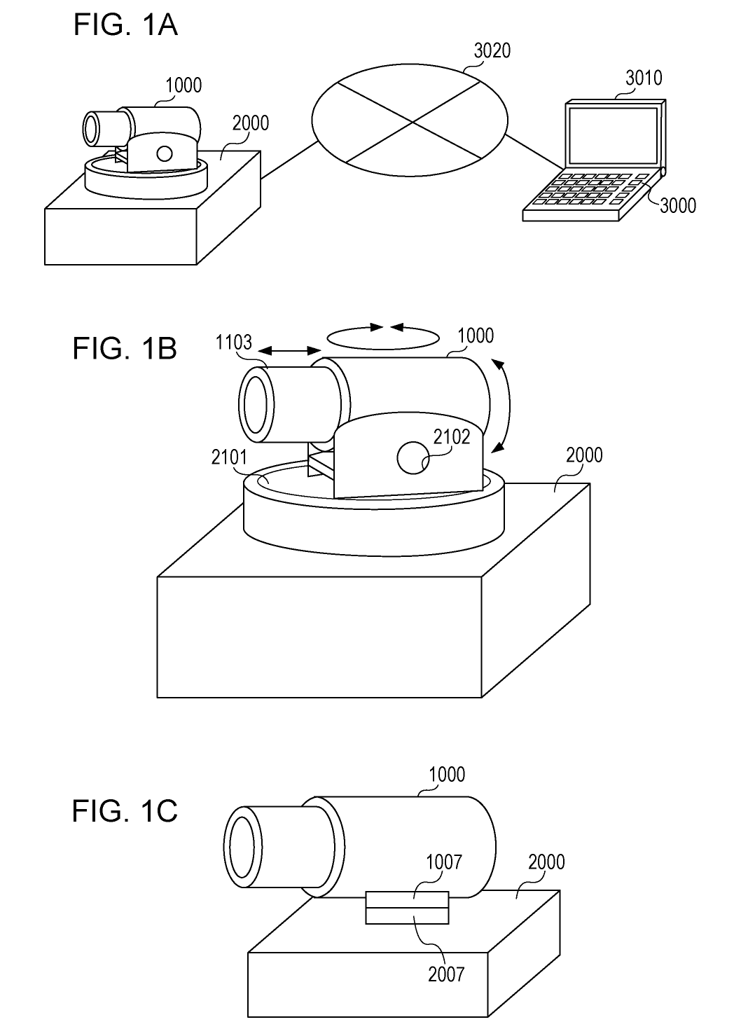

FIG. 1A illustrates the configuration of an image pickup system according to this embodiment. An image pickup system according to this embodiment, an image pickup apparatus 1000 is placed on a pan head 2000. The pan head 2000 is connected to a client 3000 via a network 3020. The pan head 2000 delivers an image captured by the image pickup apparatus 1000 to the client 3000 via the network 3020. The client 3000 transmits an instruction made by a user who operates the client 3000 to the pan head 2000 via the network 3020.

The network 3020 is formed of a plurality of routers, switches, and cables compliant with a communication standard such as Ethernet (registered trademark). In the present invention, the network 3020 may be compliant with any communication standard and have any size and any configuration on the condition that it can establish communication between the pan head 2000 and the client 3000. For example, the network 3020 may be the Internet, a wired Local AreaNetwork (LAN), a wireless LAN, or a Wide Area Network (WAN).

The client 3000 transmits an instruction to the image pickup apparatus 1000 and the pan head 2000. The client 3000 transmits an instruction for changing the image capturing direction or the angle of view of the image pickup apparatus 1000.

The image pickup apparatus 1000 according to this embodiment is movably attached to the pan head 2000 using each supporting portion. More specifically, a driving mechanism for changing an image capturing direction or an angle of view will be described with reference to FIG. 1B. A pan driving mechanism 2101 includes a pan table made of, for example, a sheet metal. The pan driving mechanism 2101 changes the image capturing direction of the image pickup apparatus 1000 placed on the pan table in a pan direction by rotating the pan table. A tilt driving mechanism 2102 includes a tilt shaft that rotatably supports the image pickup apparatus 1000 in a tilt direction. The tilt driving mechanism 2102 changes the image capturing direction of the image pickup apparatus 1000 in a tilt direction with the tilt shaft. A zoom driving mechanism 1103 changes the angle of view of the image pickup apparatus 1000. The pan driving mechanism 2101 and the tilt driving mechanism 2102 correspond to a rotation unit capable of rotating a supporting portion for supporting the image pickup apparatus 1000 in a predetermined direction.

Upon receiving a control command including an instruction for changing the image capturing direction of the image pickup apparatus 1000 from the client 3000, the pan head 2000 changes the image capturing direction of the image pickup apparatus 1000 in a Ramp mode based on the instruction. Upon receiving a control command including an instruction for changing an angle of view from the client 3000, the image pickup apparatus 1000 changes an angle of view. The Ramp mode represents the relationship between a time and a rotation speed at the time of the start and stop of rotation of the pan driving mechanism 2101 or the tilt driving mechanism 2102. That is, a user who operates the client 3000 can simplify settings in a certain situation, for example, at the time of start and stop of rotation, by designating a predetermined Ramp mode using a parameter or the like included in a control command.

The coupling between the pan head 2000 and the image pickup apparatus 1000 placed on the pan head 2000 is illustrated in FIG. 1C. A coupling portion 1007 of the image pickup apparatus 1000 and a coupling portion 2007 of the pan head 2000 are connected. More specifically, the coupling portions 1007 and 2007 are formed of, for example, deformable wires such as flexible substrates or cables and connectors, and electrically connect the image pickup apparatus 1000 and the pan head 2000. In a case where the pan driving mechanism 2101 can rotate 360 degrees or more in a predetermined direction, the electric connection can be established using, for example, a slip ring.

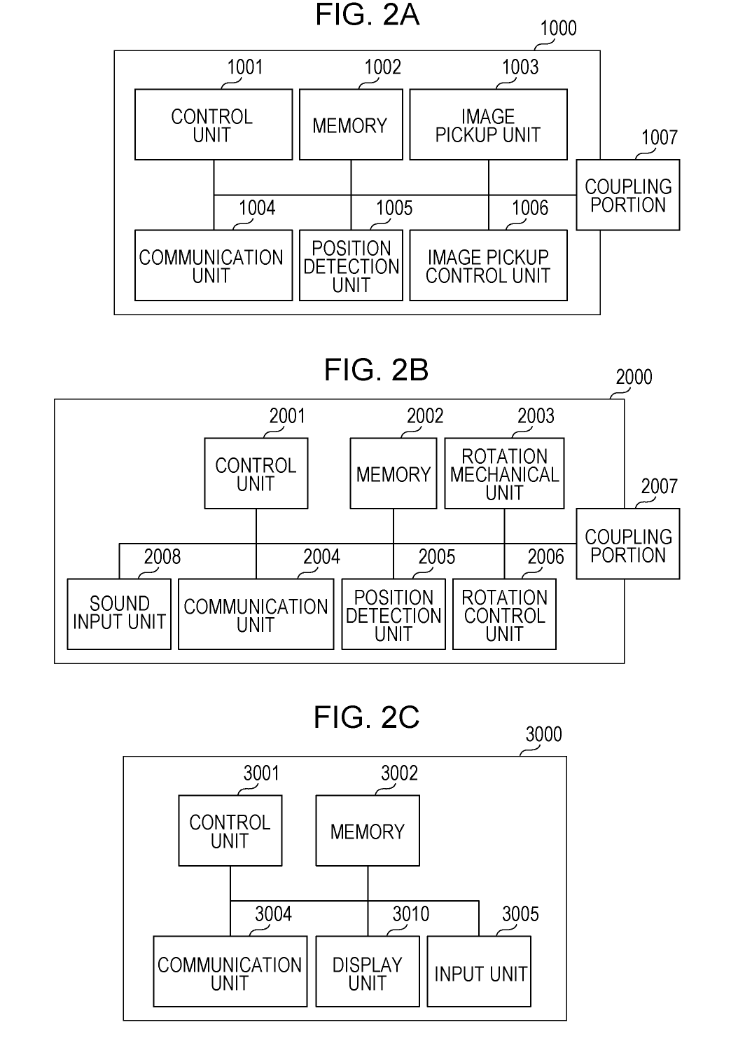

FIG. 2A illustrates the internal configuration of the image pickup apparatus 1000 according to this embodiment. Referring to FIG. 2A, a control unit 1001 performs overall control of the image pickup apparatus 1000. The control unit 1001 is formed of, for example, a Central Processing Unit (CPU) and executes a program stored in a memory 1002 to be described later.

The memory 1002 is used as data storage areas such as an area in which a program executed by the control unit 1001 is stored, a work area at the time of the execution of a program, and an area in which an image captured by an image pickup unit 1003 to be described later is stored. The memory 1002 stores a command suspension queue used to suspend the execution of a command received by a communication unit 1004 to be described later and an apparatus identifier Cam1 thereof. The device identifier corresponds to apparatus information of the image pickup apparatus 1000.

The image pickup unit 1003 captures the image of a subject using a lens and converts a generated analog signal into digital data. Furthermore, the image pickup unit 1003 performs data compression by Adaptive Discrete Cosine Transform (ADCT) to generate a captured image and outputs the captured image to the memory 1002. After outputting a captured image to the memory 1002, the image pickup unit 1003 transmits an image acquisition event to the control unit 1001.

The communication unit 1004 receives each control command from the client 3000 via the pan head 2000, and is used to transmit a response to each control command to the client 3000 via the pan head 2000.

A position detection unit 1005 detects the coordinates of the zoom driving mechanism 1103. In a case where a request for the acquisition of information about the angle of view of the image pickup apparatus 1000 is transmitted from the client 3000 to the image pickup apparatus 1000 via the pan head 2000, the position detection unit 1005 detects the coordinates of the zoom driving mechanism 1103 and transmits information about the detected coordinates to the client 3000 via the pan head 2000 as positional information.

An image pickup control unit 1006 controls the zoom driving mechanism 1103 in accordance with an instruction made by the control unit 1001. That is, when the communication unit 1004 receives an instruction for changing an angle of view from the client 3000 via the pan head 2000, a receipt event corresponding to the instruction is transmitted to the control unit 1001. Upon receiving the receipt event, the control unit 1001 makes a control instruction for the image pickup control unit 1006 on the basis of the receipt event. Upon receiving the control instruction, the image pickup control unit 1006 performs control processing to drive the zoom driving mechanism 1103 in accordance with the control instruction.

The internal configuration of the image pickup apparatus 1000 has been described. However, the processing blocks illustrated in FIG. 2A are intended to describe an example of an image pickup apparatus according to an embodiment of the present invention and are illustrative only. For example, a sound input unit such as a microphone may be provided, or a rotation mechanism for rotating an image pickup unit about an optical axis may be provided.

Next, the internal configuration of the pan head 2000 will be described with reference to FIG. 2B. Referring to FIG. 2B, a control unit 2001 performs overall control of the pan head 2000. The control unit 2001 is formed of, for example, a Central Processing Unit (CPU) and executes a program stored in a memory 2002 to be described later.

The memory 2002 is used as an area in which a program executed by the control unit 2001 is stored, a work area at the time of the execution of a program, and an area in which coordinate data representing a position in an image capturing range of the image pickup apparatus 1000 is stored. The memory 2002 stores a command suspension queue used to suspend the execution of a command received by a communication unit 2004 to be described later and Ramp information option RampSel1 which the pan head can set for itself every image pickup apparatus thereon. The control unit 2001 determines whether the setting of a Ramp mode is automatic setting on the basis of the apparatus identifier or parameter of the image pickup apparatus 1000.

A rotation mechanical unit 2003 includes the pan driving mechanism 2101 and the tilt driving mechanism 2102, and drives each mechanical unit at an angle specified by a control command. More specifically, the pan head 2000 includes an actuator (not illustrated), and changes the image capturing direction of the image pickup apparatus 1000 about a predetermined axis in a pan direction or a tilt direction using a driving force transmission portion such as a belt or a gear.

The communication unit 2004 receives each control command from the client 3000 via the network 3020, and is used to transmit a response to each control command to the client 3000 via the network 3020. Furthermore, the communication unit 2004 exchanges, for example, control information with the communication unit 1004 in the image pickup apparatus 1000. More specifically, a parameter and a user's instruction included in a control command received by the communication unit 2004 is transmitted to the image pickup apparatus 1000 via the coupling portions 2007 and 1007 as appropriate. The control unit 1001 in the image pickup apparatus 1000 performs control processing so that the parameter and the user's instruction received from the pan head 2000 is stored in the memory 1002.

A position detection unit 2005 detects the coordinates of the pan driving mechanism 2101 and the tilt driving mechanism 2102 (that is, an image capturing direction). In a case where a request for acquiring information about the angle of view of the image pickup apparatus 1000 is transmitted from the client 3000 to the image pickup apparatus 1000 via the network 3020, the position detection unit 2005 detects the coordinates of the pan driving mechanism 2101 and the tilt driving mechanism 2102 and transmits the detected coordinates to the client 3000 via the network 3020 as positional information.

A rotation control unit 2006 controls the pan driving mechanism 2101 and the tilt driving mechanism 2102 in accordance with an instruction made by the control unit 2001. That is, when the communication unit 2004 receives a command for changing an image capturing range from the client 3000, a receipt event corresponding to the command is transmitted to the control unit 2001. Upon receiving the receipt event, the control unit 2001 makes a control instruction for the rotation control unit 2006 on the basis of the receipt event. Upon receiving the control instruction, the rotation control unit 2006 performs control processing so as to drive the pan driving mechanism 2101 and the tilt driving mechanism 2102 in accordance with the control instruction. A sound input unit 2008 detects sound externally input into the pan head 2000 using, for example, a microphone.

Next, the internal configuration of the client 3000 will be described with reference to FIG. 2C. The client 3000 is a computer connected to the network 3020. A control unit 3001 performs overall control of the client 3000. The control unit 3001 is formed of, for example, a Central Processing Unit (CPU) and executes a program stored in a memory 3002 to be described later.

The memory 3002 is used as an area in which a program executed by the control unit 3001 is stored, a work area at the time of the execution of a program, and a data storage area.

A communication unit 3004 receives a captured image transmitted from the image pickup apparatus 1000 via the pan head 2000. Furthermore, the communication unit 3004 transmits a command for controlling the image pickup apparatus 1000 and the pan head 2000 and a command for requesting the acquisition of information about the image pickup apparatus 1000 and the pan head 2000.

An input unit 3005 accepts the input of a user's instruction. For example, the input unit 3005 can accept the inputs of instructions for transmitting various commands to the image pickup apparatus 1000 and the pan head 2000. Examples of the input unit 3005 include a mouse, a keyboard, a joystick, a touch panel, and the combination of them. Upon accepting the user's input of an instruction for transmitting a command to the image pickup apparatus 1000 and the pan head 2000, the input unit 3005 notifies the control unit 3001 that the instruction has been input. In accordance with the instruction input into the input unit 3005, the control unit 3001 generates a command for the image pickup apparatus 1000 and the pan head 2000 and controls the transmission of the generated command to the image pickup apparatus 1000 and the pan head 2000 via the communication unit 3004. Furthermore, the input unit 3005 can accept the input of a user's response to an inquiry that has been made for the user by causing the control unit 3001 to execute a program stored in the memory 3002.

A display unit 3010 displays a captured image received by the communication unit 3004. The display unit 3010 can also display, for example, a message about an inquiry made for a user by causing the control unit 3001 to execute a program stored in the memory 3002. A user interface (UI) (not illustrated) is formed of the display unit 3010 and the input unit 3005.

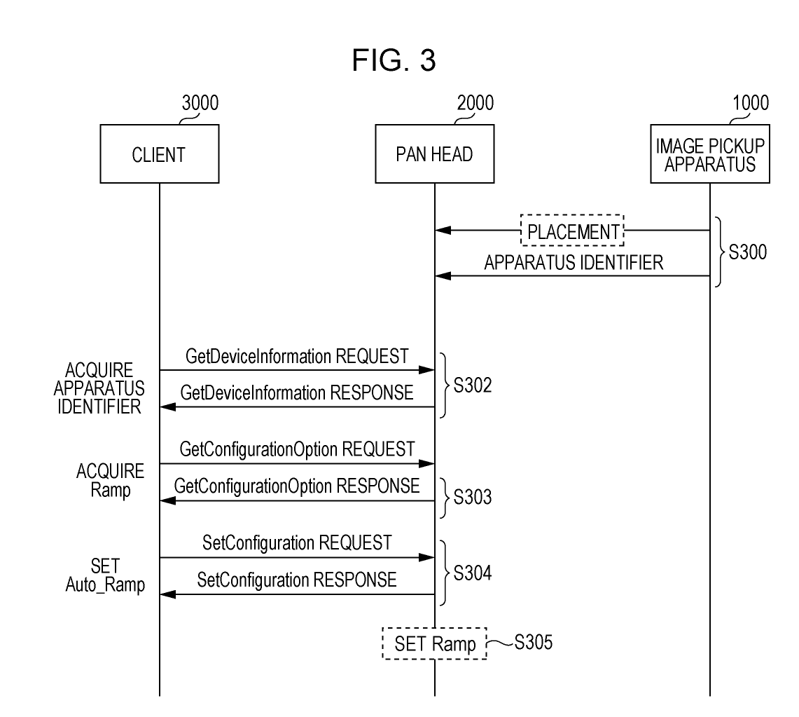

A sequence for causing the client 3000 to set the acceleration of rotation of the pan head 2000 will be described with reference to FIG. 3.

FIG. 3 illustrates a communication sequence among the image pickup apparatus 1000, the pan head 2000, and the client 3000 according to this embodiment.

First, when the image pickup apparatus 1000 is placed on the pan head 2000 in S300, the pan head 2000 acquires an apparatus identifier Cam1 of the image pickup apparatus 1000 from the image pickup apparatus 1000. This processing may be performed not only at the time of the placement of the image pickup apparatus 1000 but also at the time of power-on or reset.

In S302, the client 3000 transmits a “GetDeviceInformation request” that is an apparatus identifier acquisition command, which is one of control commands, to the pan head 2000. In response to the received control command, the pan head 2000 transmits a “GetDeviceInformation response” including the apparatus identifier Cam1 of the image pickup apparatus 1000 to the client 3000.

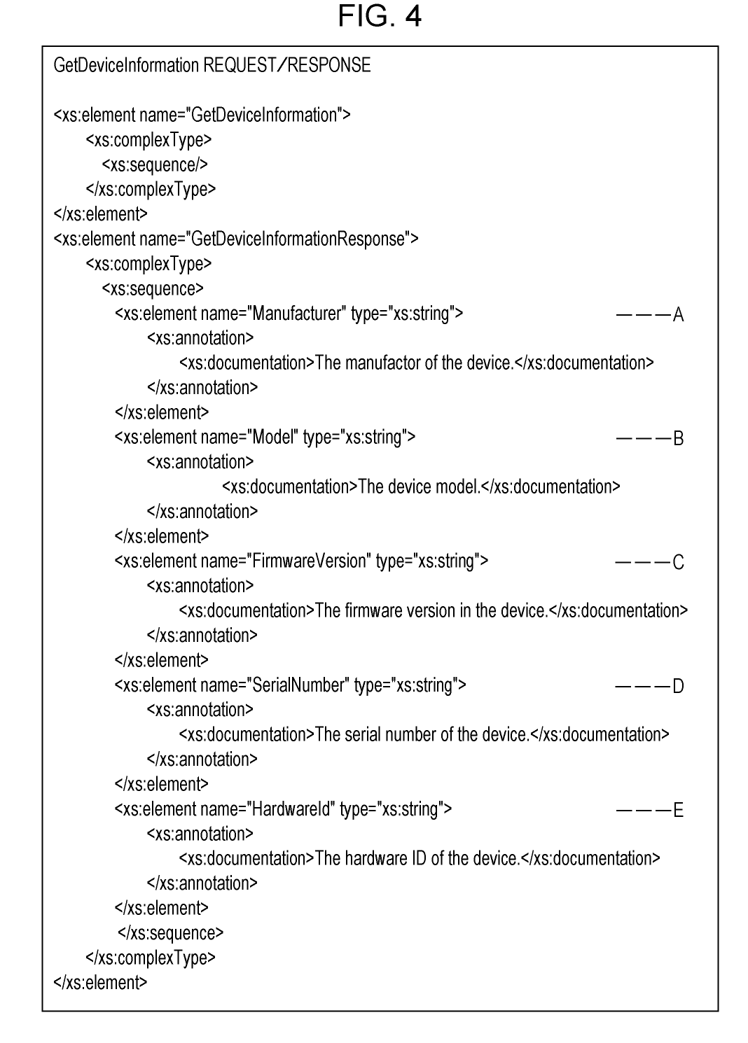

FIG. 4 illustrates the XML-written contents of each control command and each response used in FIG. 3. FIG. 4 illustrates the contents of the GetDeviceInformation request and the GetDeviceInformation response. Referring to FIG. 4, the apparatus identifier Cam1 includes a manufacturer in a line represented by −A, a model type in a line represented by −B, a firmware version in a line represented by −C, a serial number in a line represented by −D, and a hardware ID in a line represented by −E.

Referring back to FIG. 3, in S303, the client 3000 transmits a “GetConfigurationOptions request” that is a Ramp acquisition command, which is one of control commands, to the pan head 2000. This command includes the apparatus identifier Cam1 of the image pickup apparatus 1000 acquired in S302. In response to the received control command, the pan head 2000 transmits Ramp option information RampSel of the image pickup apparatus 1000 to the client 3000 as a “GetConfigurationOptions response”. Here, RampSel1 represents options of Ramp information that can be set for the pan head 2000 on which the image pickup apparatus 1000 is placed, and includes pan options and tilt options. The Ramp option information RampSel includes Ramp_SelAuto.

In S304, the client 3000 transmits a “SetConfiguration” command, which is one of control commands, to the pan head 2000. In this embodiment, it is assumed that “Ramp_SelAuto” included in RampSel acquired in S303 is set in this command.

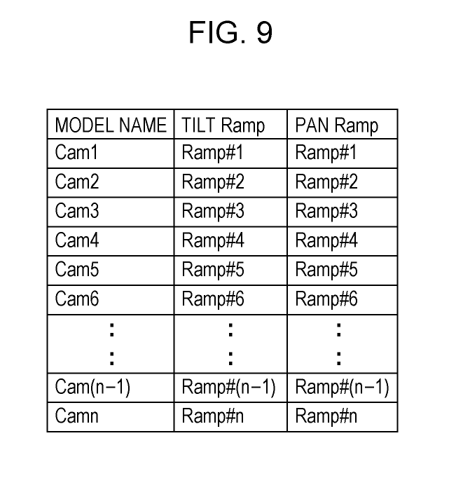

When “Ramp_SelAuto” is set in S305, the pan head 2000 automatically sets Ramp in accordance with the apparatus identifier Cam1 of the image pickup apparatus 1000. At the time of setting of Ramp, the pan head 2000 uses a table in FIG. 9 which is stored in the memory 2002. More specifically, in the table illustrated in FIG. 9, an apparatus identifier, tilt Ramp, and pan Ramp are associated with one another. It is therefore possible to automatically determine Ramp at the time of pan and tilt operations by specifying the apparatus identifier of the image pickup apparatus 1000. In this embodiment, the pan head 2000 sets Ramp#1 corresponding to the apparatus identifier Cam1 as tilt Ramp and pan Ramp.

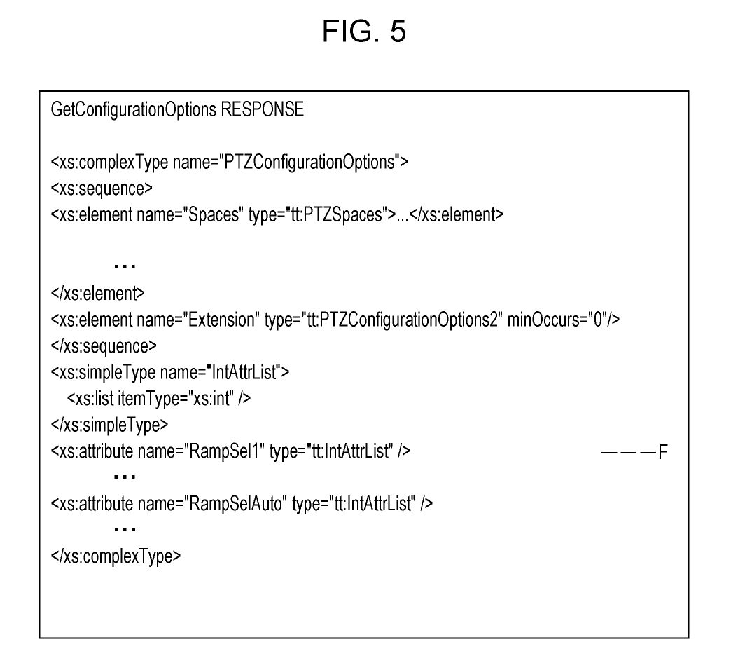

FIG. 5 illustrates the contents of the GetConfigurationOptions response. In the drawing, in a line represented by -F, the option of Ramp information represented by RampSel1 is received.

The command and the command request illustrated in FIGS. 4 and 5 include destinations of them represented by the addresses of the pan head 2000 and the image pickup apparatus 1000 that are targets to be caused to execute them, and a transmission source of them represented by the address of the client 3000. A command response includes a transmission destination of a result of a command which is represented by the address of the client 3000, and transmission sources of the result of the command which are represented by the addresses of the pan head 2000 and the image pickup apparatus 1000. Each command includes information about contents thereof and information about an argument.

As described previously, using a table storing the apparatus identifier of the image pickup apparatus 1000 and Ramp setting associated with each other, it is possible to automatically determine Ramp setting by which vibration does not occur at the time of operations such as a pan operation and a tilt operation. In a case where an apparatus identifier acquired from the image pickup apparatus 1000 does not correspond to an apparatus identifier stored in the pan head 2000, Ramp setting by which the lowest speed is set may be selected so as to prevent the occurrence of vibration. Alternatively, an inquiry may be made for the client 3000 so as to acquire setting corresponding to a new apparatus identifier via a network. In this embodiment, an apparatus identifier and Ramp setting are associated with each other. However, instead of an apparatus identifier, for example, the weight of an image pickup apparatus may be associated with Ramp setting.

In this embodiment, the apparatus identification information of the image pickup apparatus 1000 is acquired. However, in a case where a lens of the image pickup unit 1003 in the image pickup apparatus 1000 is exchangeable, the identifier of a lens may be used. In this case, a lens ID representing the type of a lens is equivalent to apparatus information and Ramp setting corresponding to the lens ID is stored in the memory 2002, so that a similar effect can be obtained. In a case where the ID of a lens is used, Ramp setting may be performed in consideration of the focal length (zoom position) of the lens in addition to the lens ID.

In this embodiment, the image pickup apparatus 1000 and the pan head 2000 include respective control units and respective memories. However, these control units may be integrated and these memories may be integrated, and the integrated control unit and the integrated memory may be used to perform overall control.

### Second Embodiment

In the first embodiment, an exemplary operation of performing Ramp setting for the pan head 2000 on the basis of setting performed via the client 3000 has been described. In the second embodiment, an exemplary operation of performing Ramp setting for the pan head 2000 without the need for setting performed via the client 3000 will be described. In this embodiment, the image pickup system, the image pickup apparatus 1000, the pan head 2000, and the client 3000 which are used in the first embodiment are used. In the second embodiment, the same reference numerals are used to identify configurations and operations already described in the first embodiment, and the description thereof will be therefore omitted.

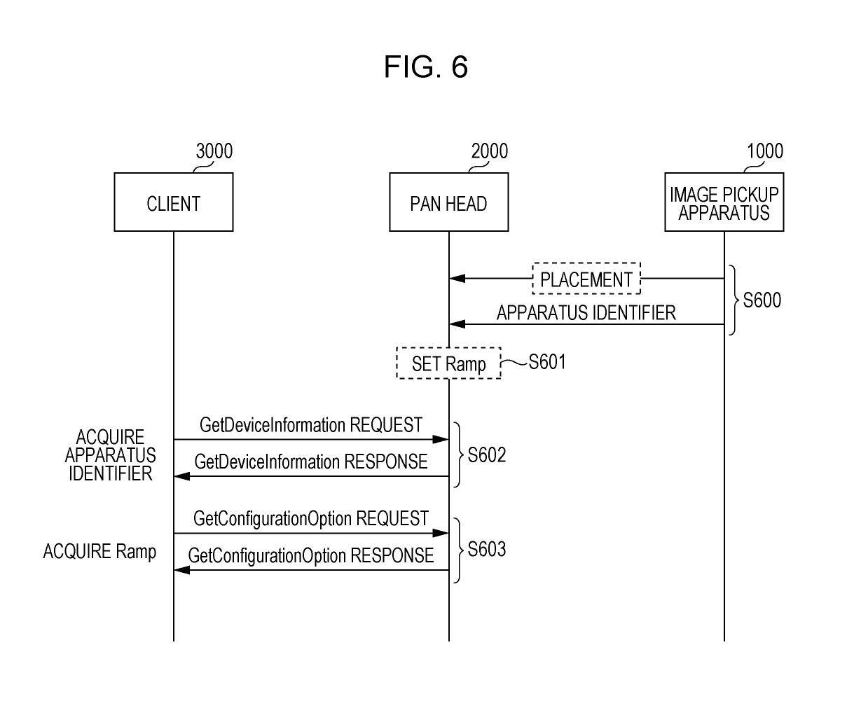

A sequence according to this embodiment will be described with reference to FIG. 6. The processing of S600 is the same as the processing of the S300, and the description thereof will be therefore omitted.

In S601, using the Ramp setting table illustrated in FIG. 9 which is stored in a memory in advance, the pan head 2000 performs Ramp setting on the basis of the acquired apparatus identifier Cam1.

In S602, the client 3000 transmits a “GetDeviceInformation request” that is an apparatus identifier acquisition command, which is one of control commands, to the pan head 2000. In response to the received control command, the pan head 2000 transmits a “GetDeviceInformation response” including the apparatus identifier Cam1 of the image pickup apparatus 1000 to the client 3000.

In S603, the client 3000 transmits a “GetConfigurationOptions” that is a Ramp acquisition command, which is one of control commands, to the pan head 2000. In response to the received control command, the pan head 2000 transmits only Ramp_SelAuto to the client 3000. Since the client 3000 stores a table similar to the table used by the pan head 2000 at the time of Ramp setting in its memory, the client 3000 can know Ramp setting conditions on the basis of the acquired apparatus identifier Cam1.

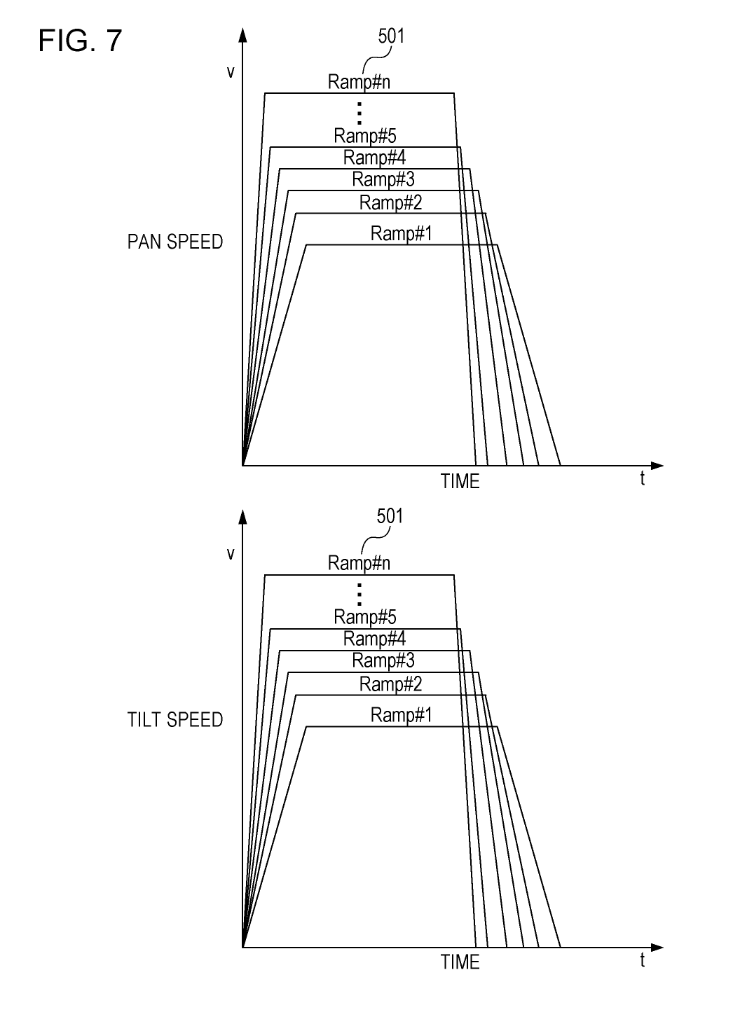

FIG. 7 illustrates details of Ramp information. Ramp#1 to Ramp#n 501 represents time-varying characteristics of a pan/tilt speed in a stop-acceleration-constant speed-deceleration-stop period. The maximum speed is usually obtained at the time of a constant speed. The higher the maximum speed, the shorter a time t taken to reach a target point.

In Ramp_SelAuto, one of Ramp1 to Ramp#n which are set in advance on the basis of the apparatus identifiers of image pickup apparatuses is automatically selected.

Thus, using a table stored in the image pickup apparatus 1000 in which an apparatus identifier and Ramp setting are associated with each other, it is possible to automatically determine Ramp setting by which vibration does not occur at the time of a pan/tilt operation without the intervention of the client 3000.

### Third Embodiment

In this embodiment, a tour mode operation of chronologically touring pan positions and tilt positions of the image pickup apparatus 1000 which are registered (preset) in advance will be described. In this embodiment, the image pickup system, the image pickup apparatus 1000, the pan head 2000, and the client 3000 which are used in the first embodiment are used. In the third embodiment, the same reference numerals are used to identify configurations and operations already described in the first and second embodiments, and the description thereof will be therefore omitted.

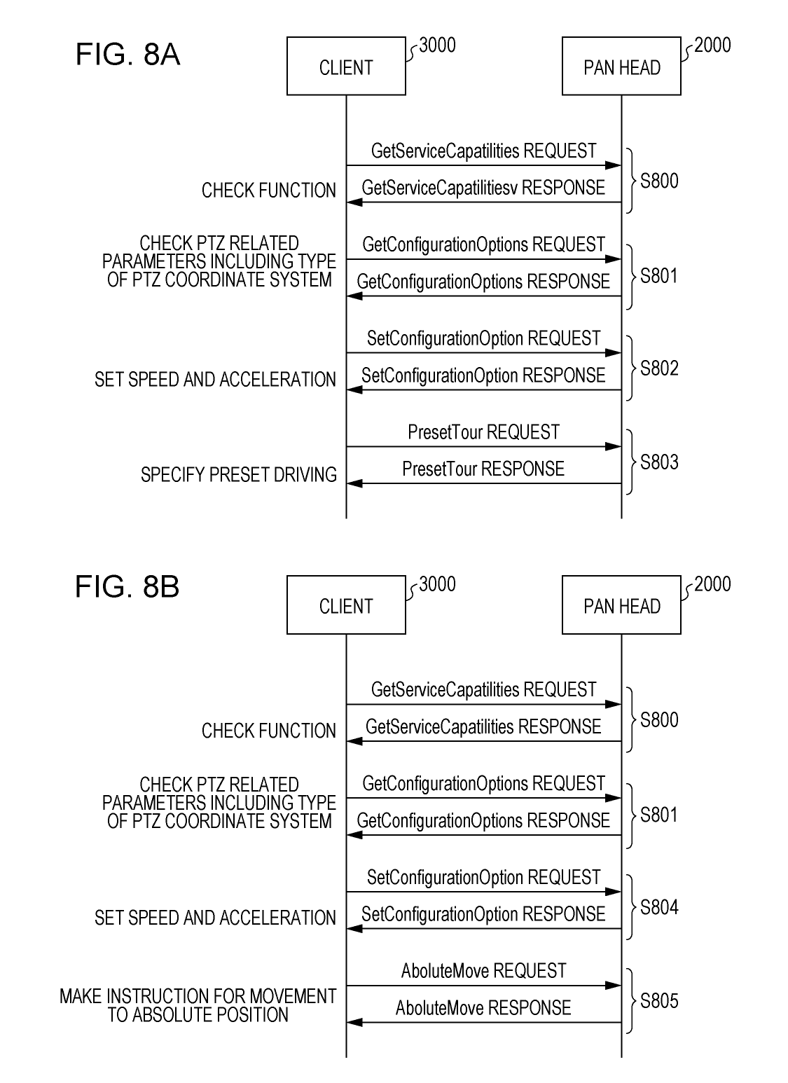

A method of performing Ramp setting using a tour mode will be described with reference to a sequence illustrated in FIG. 8A.

In S800, the client 3000 transmits “GetServiceCapabilities” that is one of control commands to the pan head 2000. Upon receiving the control command, the pan head 2000 transmits a response including information about the function of the pan head 2000 to the client 3000. After this communication, the client 3000 knows the function of the pan head 2000 and can reflect it in, for example, a user interface (UI) of the client 3000. In this embodiment, it is assumed that the pan head 2000 can set a speed and acceleration at the time of a pan/tilt operation.

In S801, the client 3000 transmits “GetConfigurationOptions” that is one of control commands to the pan head 2000. Upon receiving the control command, the pan head 2000 transmits a response including parameters such as the coordinates of a pan/tilt position of the pan head 2000, a pan/tilt speed, and acceleration to the client 3000. After this communication, the client 3000 knows the pan/tilt position of the pan head 2000 and can reflect it in, for example, a UI of the client 3000.

In S802, the client 3000 transmits “SetConfigurationOptions” that is one of control commands to the pan head 2000. This control command includes parameters such as a pan/tilt speed and acceleration specified by a user via, for example, the UI of the client 3000. Upon receiving the control command, the pan head 2000 performs setting of each component. The pan head 2000 transmits a response indicating that setting has been normally performed to the client 3000. After this communication, the client 3000 can set the pan/tilt speed and acceleration of the pan head 2000.

In S803, the client 3000 transmits “PresetTour” that is one of control commands to the pan head 2000. This control command includes a parameter instructing the setting of a tour mode in which the image pickup apparatus 1000 repeatedly performs image capturing along a tour sequence specified by a user using, for example, the UI of the client 3000. The arguments of the PresetTour include PTZSpeed used to set a speed. There is an Extension area that is an additional argument area, and a PTZAccelaration argument that is a command for specifying acceleration is inserted in the area. In a case where acceleration is specified using an argument, the specified acceleration is used at the time of driving. In a case where an argument is set, acceleration specified with Set-Configuration is used. In a case where the setting of an argument is not performed with SetConfiguration, default acceleration is used at the time of driving. In a case where information about the GetConfigurationOptions response does not include acceleration setting information, driving is performed with acceleration unique to an image pickup apparatus at the time of the transmission of the PresetTour command. After receiving the control command, the pan head 2000 performs setting for each component. Subsequently, the pan head 2000 transmits a response indicating that setting has been normally performed to the client 3000. After this communication, the client 3000 can control the tour mode of the pan head 2000.

Next, a method of controlling the pan/tilt operation of the pan head 2000 will be described along a sequence illustrated in FIG. 8B. The process from S800 to S801 is the same as that in FIG. 8A, and the description thereof will be therefore omitted.

In S804, the client 3000 transmits “SetConfigurationOptions” that is one of control commands to the pan head 2000. This control command includes parameters such as a default speed and default acceleration specified by a user using, for example, the UI of the client 3000. More specifically, desired values are set to arguments of the SetConfiguration, that is, DefaultPTZSpeed representing default speed information and DefaultPTZAccelaration representing default acceleration information, and a control command including these arguments is transmitted. After receiving the control command, the pan head 2000 performs setting for each component. Subsequently, the pan head 2000 transmits a response indicating that setting has been normally performed to the client 3000.

In S805, the client 3000 transmits “AbsoluteMove” that is one of control commands to the pan head 2000. This control command includes absolute coordinates used for pan/tilt control, and pan/tilt control is performed so that movement to specified absolute coordinates is achieved. Alternatively, “GotoHomePositionMove” with which the movement to a home position is achieved may be transmitted.

For the above-described control command, an argument PTZSpeed for specifying a speed may be set, but does not necessarily have to be set. In this embodiment, it is assumed that the AbsoluteMove command for which the argument PTZSpeed is set is transmitted. In this case, pan/tilt control is performed on the basis of PTZSpeed set as an argument and DefaultPTZAccelaration representing default acceleration information set in S804.

In a case where the AbsoluteMove command for which the argument PTZSpeed is not set is transmitted, pan/tilt control is performed on the basis of DefaultPTZSpeed representing default speed information and DefaultPTZAccelaration representing default acceleration information which have been set in S804.

In this embodiment, an exemplary operation of setting default acceleration using a control command in S802 and S803 has been described. However, as described in the first embodiment, the setting of default acceleration may be performed using a table stored in the memory 2002 in the pan head 2000. More specifically, using a table stored in the image pickup apparatus 1000 in which an apparatus identifier and Ramp setting are associated with each other, it is possible to automatically determine Ramp setting by which vibration does not occur at the time of a pan/tilt operation without the intervention of the client 3000.

### Fourth Embodiment

In the above-described embodiment, an exemplary operation of performing Ramp setting on the basis of setting performed via the client 3000 using a table in which an apparatus identifier and Ramp setting are associated with each other has been described. In this embodiment, a table different from the table according to the first embodiment is used. In this embodiment, the image pickup system, the image pickup apparatus 1000, the pan head 2000, and the client 3000 which are used in the first embodiment are used. In the fourth embodiment, the same reference numerals are used to identify configurations and operations already described in the first embodiment, and the description thereof will be therefore omitted.

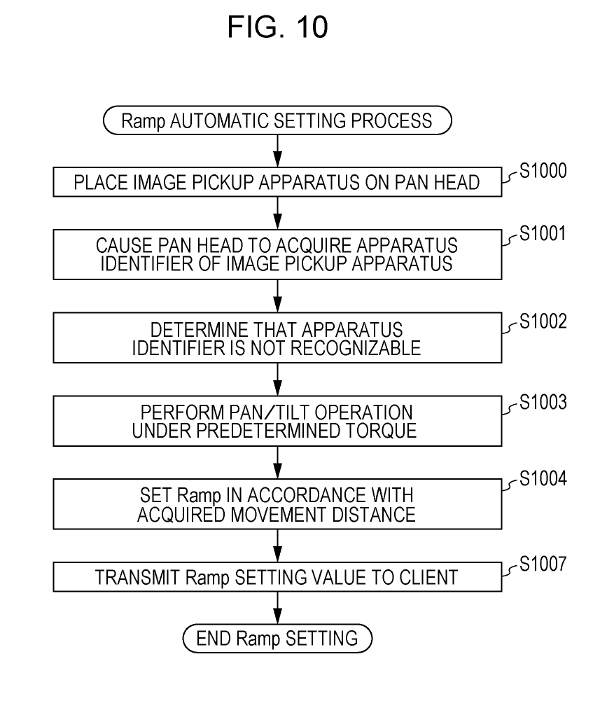

A process of performing Ramp setting on the basis of a result of a pan/tilt operation performed under a predetermined torque will be described with reference to a flowchart in FIG. 10. This process is performed by the control unit 2001.

In S1000, the control unit 2001 detects whether the image pickup apparatus 1000 is placed on the pan head 2000. After the detection, the process proceeds to S1001.

In S1001, the control unit 2001 acquires the apparatus identifier of the image pickup apparatus 1000. Subsequently, the process proceeds to S1002.

In S1002, the control unit 2001 determines whether the apparatus identifier acquired in S1001 is recognizable. In a case where it is determined that the apparatus identifier is not recognizable, the process proceeds to S1003. In a case where it is determined that the apparatus identifier is recognizable, the operation described in the first embodiment is performed and the description thereof will be therefore omitted.

In S1003, the control unit 2001 performs a pan/tilt operation under a predetermined torque. More specifically, the control unit 2001 sets a predetermined torque value for the rotation control unit 2006 as a parameter and instructs the rotation control unit 2006 to start control. In accordance with the instruction, the rotation control unit 2006 controls the rotation mechanical unit 2003 to perform a pan/tilt operation. Subsequently, the process proceeds to S1004.

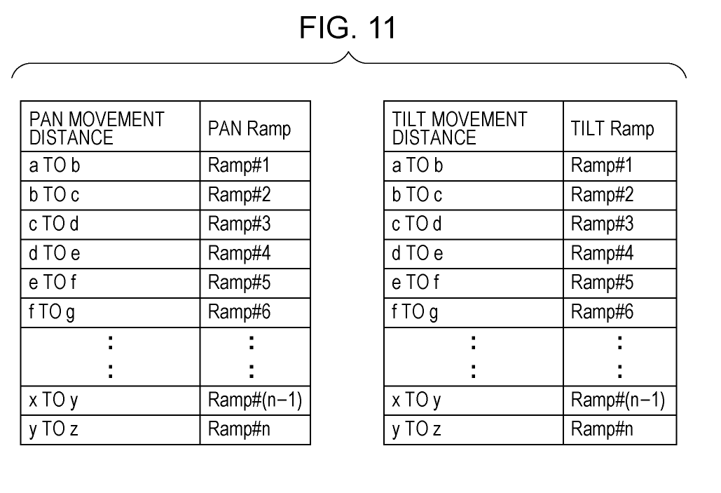

In S1004, the control unit 2001 acquires a movement distance during the operation of S1003 from the position detection unit 2005. The control unit 2001 performs Ramp setting on the basis of the acquired movement distance. FIG. 11 illustrates a table in which an acquired movement distance and Ramp setting are associated with each other. Using this table, Ramp setting is performed. Subsequently, the process proceeds to S1007.

In S1007, the control unit 2001 transmits a Ramp setting value set in S1004 to the client 3000 as appropriate. The process ends.

Thus, by applying a predetermined torque and performing a pan/tilt operation under the predetermined torque in a case where an apparatus identifier is not recognizable, it is possible to automatically determine Ramp setting by which vibration does not occur at the time of a pan/tilt operation without the intervention of the client 3000.

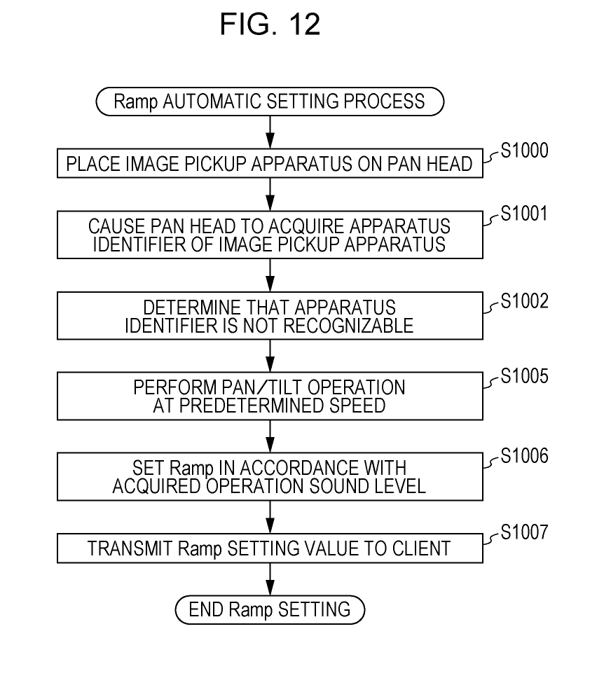

Next, a process of performing Ramp setting on the basis of a result of a pan/tilt operation performed at a constant speed will be described with reference to a flowchart in FIG. 12. This process is performed by the control unit 2001. The same reference numerals are used to identify pieces of processing already described with reference to FIG. 10, and the description thereof will be therefore omitted.

The process from S1000 to S1002 is the same as that in FIG. 10, and the description thereof will be therefore omitted.

In S1005, the control unit 2001 performs a pan/tilt operation at a predetermined speed. More specifically, the control unit 2001 sets a predetermined speed value for the rotation control unit 2006 as a parameter and instructs the rotation control unit 2006 to start control processing. In accordance with the instruction, the rotation control unit 2006 controls the rotation mechanical unit 2003 to perform a pan/tilt operation. It can be checked whether an operation is performed at a constant speed on the basis of a movement distance per unit time detected by the position detection unit 2005. Subsequently, the process proceeds to S1006.

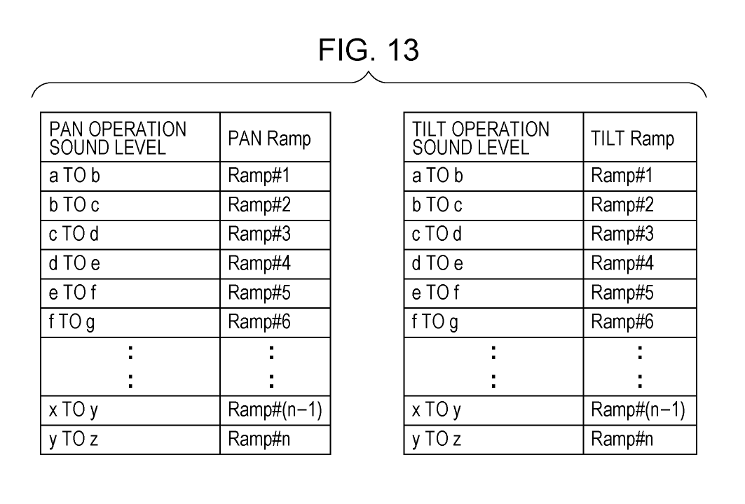

In S1006, the control unit 2001 causes the sound input unit 2008 to detect a sound level during movement. The control unit 2001 performs Ramp setting on the basis of an acquired operation sound level. FIG. 13 illustrates a table in which an acquired operation sound level and Ramp setting are associated with each other. Using this table, Ramp setting is performed. Subsequently, the process proceeds to S1007. The sound input unit 2008 corresponds to a measurement unit for measuring an operation sound level.

The processing of S1007 is the same as that in FIG. 10, and the description thereof will be therefore omitted. Subsequently, the process ends.

As described previously, Ramp setting is performed using a table in accordance with a movement distance or a sound level during movement detected when a pan/tilt operation is performed at the time of a preset, a preset tour, or the specification of an absolute value. As a result, it is possible to perform Ramp setting even for an apparatus for which Ramp setting cannot be performed using an apparatus identifier without causing a user to perform selection.

### Other Embodiments

Embodiments of the present invention can also be realized by supplying a program for realizing the functions of one or more of the above-described embodiments to a system or an apparatus via a network or a storage medium and causing one or more processors in the computer of the system or apparatus to read out and execute the program. Furthermore, embodiments of the present invention can also be realized by a circuit (e.g., application specific integrated circuit (ASIC)) for performing the functions of one or more of the above-described embodiments.

While the exemplary embodiments of the present invention have been described, it is to be understood that the invention is not limited to the embodiments and various modifications and changes can be made to the embodiments within the scope of the present invention.

According to an embodiment of the present invention, a user can automatically and intuitively perform appropriate setting for an image pickup apparatus mounted on a pan head in accordance with conditions of the image pickup apparatus without a complicated operation.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-161356 filed Aug. 18, 2015 which is hereby incorporated by reference herein in its entirety.

1. A pan head provided with a communication unit for communicating with an external apparatus via a network and a supporting portion that supports an image pickup apparatus, comprising:
a rotation unit configured to rotate the supporting portion in a predetermined direction;
a storage unit configured to store a parameter used to control the rotation unit;
a determination unit configured to determine an acceleration setting when the rotation unit rotates the supporting portion which is included in the parameter; and
an acquisition unit configured to acquire apparatus information of the image pickup apparatus,
wherein acceleration settings stored in the storage unit include an acceleration setting associated with the apparatus information, and
wherein the determination unit determines an acceleration setting at the time of rotation of the supporting portion on the basis of the acceleration setting associated with the apparatus information acquired by the acquisition unit.

2. The pan head according to claim 1, wherein the apparatus information includes information used to identify an apparatus.

3. The pan head according to claim 1, wherein the apparatus information includes information used to identify a lens of the image pickup apparatus.

4. The pan head according to claim 1, wherein the communication unit includes a receiving unit configured to receive a control command from an external apparatus, and
wherein, in a case where the control command includes an instruction for causing the determination unit to automatically determine an acceleration setting, the determination unit determines an acceleration setting associated with the apparatus information.

5. The pan head according to claim 1, wherein the control command includes a command for making an inquiry about an acceleration setting stored in the storage unit, and
wherein a response to the control command includes an acceleration setting that the determination unit has automatically determined.

6. The pan head according to claim 1, wherein operations of causing the rotation unit to rotate the supporting portion in a predetermined direction include an operation based on a preset set in advance.

7. The pan head according to claim 1, wherein operations of causing the rotation unit to rotate the supporting portion in a predetermined direction include an operation based on a position specified by an absolute position.

8. The pan head according to claim 1, further comprising a detection unit configured to detect a movement distance of the supporting portion rotated by the rotation unit under a predetermined torque,
wherein acceleration settings stored in the storage unit include an acceleration setting associated with the movement distance, and
wherein the determination unit determines an acceleration setting at the time of rotation of the supporting portion on the basis of an acceleration setting associated with the movement distance acquired by the detection unit.

9. The pan head according to claim 1, further comprising a measurement unit configured to measure an operation sound level when the rotation unit rotates the supporting portion at a predetermined speed,
wherein acceleration settings stored in the storage unit include an acceleration setting associated with the operation sound level, and
wherein the determination unit determines an acceleration setting at the time of rotation of the supporting portion on the basis of an acceleration setting associated with the operation sound level acquired by the measurement unit.

10. The pan head according to claim 1, wherein the rotation unit can rotate the supporting portion in a pan direction or a tilt direction.

11. A control method for a pan head including a communication unit for communicating with an external apparatus via a network, a supporting portion that supports an image pickup apparatus, a rotation unit for rotating the supporting portion in a predetermined direction, and a storage unit for storing a parameter used to control the rotation unit, comprising:
acquiring apparatus information of the image pickup apparatus; and
determining an acceleration setting at the time of rotation of the supporting portion on the basis of an acceleration setting associated with the apparatus information acquired in the acquiring.
